(19) United States
(12) Patent Application Publication
(10) Pub. No.: US 2026/0167807 A1
(43) Pub. Date: Jun. 18, 2026

(54) RUBBER COMPOSITION

(71) Applicant: BAKELITE GMBH, Iserlohn-Letmathe (DE)

(72) Inventors: Stephan Schröter, Iserlohn-Letmathe (DE); Michael Mindner, Iserlohn-Letmathe (DE)

(21) Appl. No.: 19/419,419

(22) Filed: Dec. 15, 2025

(30) Foreign Application Priority Data
Dec. 17, 2024 (EP) 24220556.5

(51) Int. Cl. C08L 9/06; B60C 1/00; C08K 3/04; C08K 3/22; C08K 5/01; C08K 5/18; C08K 5/3437

(52) U.S. Cl. CPC C08L 9/06; B60C 1/0016; B60C 1/0025; C08K 3/04; C08K 5/01; C08K 5/18; C08K 5/3437; C08K 2003/2296; C08L 2205/03; C08L 2205/08

(57) ABSTRACT

The invention relates to a composition composed of at least one base polymer composed of at least one rubber component and a phenolic resin. To provide a rubber composition in which the phenolic resin is better incorporated into the rubber compound and the phenolic resin has good compatibility in relation to the rubber component, it is proposed that the phenolic resin be a benzylated alkylphenol novolak resin, which has been prepared by reacting an alkylphenol novolak resin with a benzylating agent.

### BACKGROUND OF THE INVENTION

### Field of the Invention

The invention relates to a composition containing at least one base polymer and at least one benzylated alkylphenol resin.

### Description of the Related Art

The manufacture of many rubber articles requires that the individual component parts have good building tack in the unvulcanized state, so that said component parts remain in the desired position until vulcanization. To increase building tack, it has long been known to add so-called tackifying resins to the rubber compound. Examples of typical tackifying resins used in the rubber industry are coumarone-indene resins, petroleum resins, terpene phenolic resins, rosin resins or phenolic resins.

Phenolic resins are known in the manufacture of rubber products, in particular tire parts. Besides increasing building tack (e.g. U.S. Pat. No. 3,962,156), phenolic resins bring about stiffness in the final product owing to the formation its own network. In addition, they can be used as crosslinkers in certain rubber types, for example butyl rubber (DE 16 69 863 A1). If rubber compounds are to be used for adherence to textile or metallic reinforcing supports, phenolic resins can increase the binding to the reinforcing supports (e.g. DE 30 33 711 A1).

To obtain both processing-related advantages (e.g. tack) and improvements in the properties of the vulcanized product when using phenolic resins, it is essential to increase the compatibility of the phenolic resin in relation to the rubber component.

### SUMMARY OF THE INVENTION

It is therefore an object of the invention to provide a rubber composition in which the phenolic resin is better incorporated into the rubber compound and the phenolic resin has good compatibility in relation to the rubber component, which means good building tack and, at the same time, outstanding processability of the rubber composition.

The object is achieved according to the invention by the composition containing at least one base polymer and at least one benzylated alkylphenol novolak resin, wherein
a) the base polymer is selected from at least one rubber component and
b) the benzylated alkylphenol novolak resin has been prepared by reacting the alkylphenol novolak resin with a benzylating agent.

### DETAILED DESCRIPTION

It has been found that, surprisingly, the use of the benzylated alkylphenol novolak resin increased the compatibility in relation to the base polymer composed of at least one rubber component. One reason for this effect may be the reduced polarity of the resin and thus the improved binding in relation to the nonpolar rubber component. As a result, the building tack is at a similarly high level compared to conventional rubber compounds, making the composition according to the invention particularly suitable especially, for example, for manufacturing tire parts, such as treads or side walls. Another reason for why the building tack is very good is that the benzylated alkylphenol novolak resin can completely melt in the rubber compound in the mixing operation, since the resin has a lower softening point than, for example, non-benzylated alkylphenol novolak resins.

Apart from the low melting range of the benzylated alkylphenol novolak resins, it has additionally been found that the modification of the alkylphenol resin by the benzylation reaction surprisingly also reduces the melt viscosity of the resin. Neither the lowered melting range nor the reduced melt viscosity were expected, since molar mass is increased by the benzylation reaction, the result of which is usually a higher softening range and a higher melt viscosity. The lowered melting range and the reduced melt viscosity mean a more rapid melting behaviour and thus more rapid distribution of the benzylated alkylphenol novolak resin in the rubber compound. In addition, the lower melting range of the benzylated alkylphenol novolak resins can reduce mixer or roll temperatures, which can help to save energy. Also, environmentally unfriendly emissions in the mixing operation may be lowered by a reduced mixing temperature.

The composition according to the invention contains at least one rubber component as base polymer. It is preferred when the rubber component is selected from the group of the natural and synthetic polyisoprenes, styrene-butadiene copolymers, in particular emulsion-polymerized styrene-butadiene rubber and solution-polymerized styrene-butadiene rubber, polybutadienes, polyisobutylene, isobutene-isoprene copolymers, acrylonitrile-butadiene copolymers and polyoctenamers, propylene-ethylene copolymers, ethylene-propylene-diene copolymers, halobutyl rubbers, chloroprene rubbers, isoprene-butadiene copolymers and/or styrene-isoprene-butadiene terpolymers.

Said rubber components, which can also be coupled and/or modified and/or functionalized, are known from the prior art, can be readily processed to form the rubber composition according to the invention, and impart good properties to the vulcanized product, in particular tire parts.

Depending on the field of application of the vulcanized product, further possible rubber components may, for example, also be fluororubber, chlorosulfonated polyethylene (CSM) and/or ethylene-vinyl acetate copolymer (EVM).

It is particularly preferred to use an emulsion-polymerized styrene-butadiene copolymer (ESBR) and/or a solution-polymerized styrene-butadiene copolymer (SSBR) as a rubber component. The types known from the prior art that are obtained by copolymerization of styrene and 1,3-butadiene in an aqueous emulsion may be used for preparing ESBR. SSBR may be prepared, for example, using alkyllithium compounds in an organic solvent. Mixtures of ESBR and SSBR may also be used as rubber component for the composition according to the invention. The styrene-butadiene copolymers may also be coupled and end group-modified.

Furthermore, it is preferred when the rubber component is selected from polyisoprene (IR, NR). This may be either cis-1,4-polyisoprene or 3,4-polyisoprene. Preference is given to using cis-1,4-polyisoprenene having a cis-1,4 content of >90% by weight. Such a polyisoprene can be obtained synthetically by stereospecific polymerization in solution with Ziegler-Natta catalysts or using finely dispersed alkyllithium compounds. Natural rubber (NR) is a cis-1,4-polyisoprene having a cis-1,4 content of greater than 99% by weight.

Advantageously, the composition according to the invention comprises polybutadiene (BR) as rubber component, which may be either cis-1,4-polybutadiene or vinyl polybutadiene (vinyl content of 10-90% by weight). Preference is given to using cis-1,4-polybutadiene having a cis-1,4 content of greater than 90% by weight, which can be prepared, for example, by solution polymerization in the presence of rare earth catalysts.

The composition according to the invention contains at least one benzylated alkylphenol novolak resin as a further component, obtained by reacting the alkylphenol novolak resin with a benzylating agent.

According to the application, alkylphenol novolak resins are understood to mean resins which are produced by condensation of at least one alkylphenol with at least one aldehyde or by addition of at least one alkylphenol to unsaturated compounds (e.g. alkenes, alkynes, unsaturated resins). The alkylphenol novolak resin may, however, also be prepared using mixtures of alkylphenols with other phenols (e.g. phenol, cresols, bisphenols), though in such mixtures, the alkylphenol content should be at least 70%. This is because, in the case of alkylphenol novolak resins prepared using alkylphenol/phenol mixtures, it has been found that an increasing content of short-chain phenols in the mixture reduced building tack.

Alkylphenols are prepared by alkylating phenolic compounds. The phenolic compounds are preferably selected from the group consisting of unsubstituted and substituted phenols, for example phenol, cresols, catechol, hydroquinone, resorcinol and/or bisphenols, for example bisphenol A and/or bisphenol F and/or cashew nutshell liquid (CNSL).

The alkylation reaction including the alkylating agents are known from the prior art. What are obtained are alkylphenols having preferably C₄ to C₁₂-alkyl chains (branched or unbranched). The corresponding alkyl substituents of the phenol may be in the para or ortho position in relation to the OH group, though mixtures of o-und p-alkylphenols may also be used. Preference is given to using C₄ to C₁₂-alkylphenols, in particular butylphenol isomers and/or tert-butylphenol (preferably p-tert-butylphenol) and/or butylphenol and/or octylphenol isomers and/or tert-octylphenol (preferably p-tert-octylphenol) and/or octylphenol, and/or nonylphenol isomers and/or dodecylphenol isomers, since these products are simple to prepare and therefore readily commercially available.

The alkylphenol novolak resin is prepared by condensing at least one alkylphenol with at least one aldehyde, preferably formaldehyde, p-formaldehyde, acetaldehyde, furfuryl aldehyde or benzaldehyde. The alkylphenol is used in a molar ratio of alkylphenol to aldehyde of 1:0.2 to 1:>1.0, preferably 1:0.5 to 1:0.9, and an acid catalyst is used. The specific molar ratio yields solid alkylphenol novolak resins having a softening point of greater than 60° C. that are easy to handle. The acid catalysts used are usually, for example, oxalic acid or p-toluenesulfonic acid, benzenesulfonic acid, hydrochloric acid, sulfuric acid, phenolsulfonic acid and metal salts, or mixtures of two or more thereof. This reaction is also known to a person skilled in the art. Furthermore, it is possible for the alkylphenol to react with an unsaturated compound such as alkenes or alkynes (e.g. acetylene) or unsaturated resins (e.g. terpene resins) by way of an addition reaction, thus preparing an alkylphenol novolak resin (e.g. S. Schröter: Klebharze, Hinterwaldner Verlag Munich, 1994, page 137 or A, Gardziella, L. A. Pilato, A. Knop: Phenolic Resins, 2nd edition, Springer Verlag, 1999, page 22).

The result is alkylphenol novolak resins having alkyl radicals on the phenol ring preferably in the o- and/or p-position having branched and/or unbranched alkyl radicals having preferably up to 12 carbon atoms.

The benzylated alkylphenol novolak resin is prepared by reacting the alkylphenol novolak resin with a benzylating agent (e.g. in an alkylphenol novolak resin: benzylating agent molar ratio of 1:1.2 to 1:2.4) preferably selected from benzyl alcohol, benzyl chloride, benzyl bromide, benzyl ether and/or derivatives thereof in an acidic medium. The alkylphenol novolak resin is heated together with the benzylating agent, for example with the benzyl alcohol, to approx. 160° C. This is followed by adding 0.1% to 1% of a suitable acid (oxalic acid, p-toluenesulfonic acid, benzenesulfonic acid, hydrochloric acid, sulfuric acid, phenolsulfonic acid, phosphoric acid, metal salts, or mixtures of two or more thereof). The water formed by the reaction is removed by distillation. The reaction is completed when most of the benzyl alcohol has reacted.

However, it is also possible for the alkylphenol novolak resin to be in the form of a melt. Also, the benzylating agent may be added over a relatively long period.

An example equation for the reaction of an alkylphenol novolak resin with benzyl alcohol is provided here schematically:

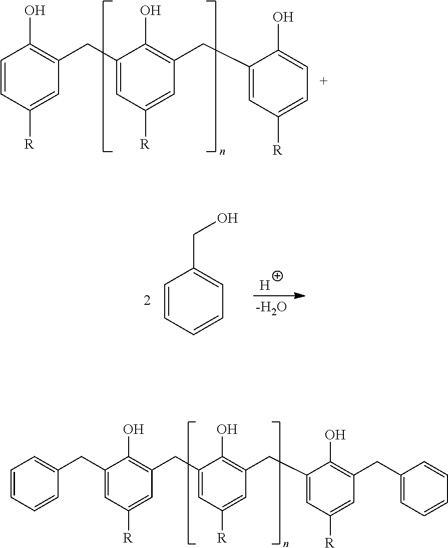

Where n: 0-20 on average; R: branched or unbranched alkyl groups, preferably C₄-C₁₂

In a preferred embodiment, the composition according to the invention contains the benzylated alkylphenol novolak resin in an amount of 0.1 to 30 phr (parts per hundred parts rubber by weight). The properties of the vulcanisate worsened with contents greater than 30 phr. Preferably, the content of benzylated alkylphenol novolak resin used is 1 to 10 phr, particularly preferably 2-6 phr. Within this range, a balanced relationship between processability, building tack and vulcanisate properties was achieved.

The composition according to the invention may additionally contain other customary additives in customary concentrations, for example other resins, processing aids, fillers, ageing inhibitors, activators, plasticizers, vulcanization aids and/or vulcanization accelerants.

The other resins may be, for example, hydrocarbon resins based on, for example, terpene phenol, polyterpene (rosin), α-limonene, β-pinene, indene-coumarone resins, other phenolic resins or pentaerythritol ester, for example in a concentration of 0 to 20 phr. Also suitable are phenol novolaks with hexamethylenetetramine as reinforcing resins, optionally modified with an approx. 20% content of cashew nutshell liquid or tall oil, in order to establish better compatibility with the rubber component.

The processing aids used are customary chemicals, for example stearic acid, factice, dispersants, processing oils, waxes, fats or metal salts, for ensuring optimal processing of the mixture for the particular area of application and obtaining corresponding vulcanized products having the desired properties.

The composition according to the invention generally comprises fillers which have a reinforcing effect in the rubber compound and/or in the vulcanized product, for example carbon black, silica, aluminosilicates, chalk, starch, magnesium oxide, titanium dioxide or rubber gels. The amount of fillers is preferably 0.1 phr to 200 phr.

Particular preference is given to the use of carbon black and/or silica, preferably in an amount of 0.1 phr to 200 phr. The carbon blacks used are those as generally used in rubber compounds. Preferred silicas are finely dispersed, precipitated silicas having, for example, a nitrogen surface area (BET surface area) (according to DIN 66131 and 66132) of 35 to 350 m2. Such silicas result in particularly good physical properties of the vulcanisates, for example in rubber compounds for tire treads. For improved processability and for binding of the silica to the rubber component, it is advantageous when coupling agents such as silanes are added as additives to the composition according to the invention.

Ageing inhibitors include, for example, N-phenyl-N′-(1,3-dimethylbutyl)-p-phenylenediamine (6PPD), N-isopropyl-N′-phenyl-p-phenylenediamine (IPPD), 2,2,4-trimethyl-1,2-dihydroquinoline (TMQ) and other substances, as known for example from J. Schnetger, Lexikon der Kautschuktechnik, 2nd edition, Hüthig Buch Verlag, Heidelberg, 1991, pages 42-48.

Furthermore, customary activators may be present in the rubber compound. Said activators may be zinc oxide and fatty acids or zinc soaps based on zinc oxide and fatty acids. Alternatively, mixtures of zinc oxide and metal acrylate and/or metal methacrylate may be used. They are preferably used in an amount of 0.1 to 3.0 phr of zinc oxide and in an amount of 0.1 to 3.0 phr of metal acrylate and/or metal methacrylate.

Preferably, the plasticizer used is mineral oil; as an alternative or in addition, liquid polymers suitable inter alia as plasticizers as substitutes for mineral oils may also be used. The plasticizers, preferably mineral oils, are used in an amount of 1 to 160 phr, such as 5 to 75 phr, in particular 10 to 60 phr. The liquid polymers, for example liquid polybutadiene, have accordingly amounts of 0 to 160 phr, but at least 0.1 phr, such as 5 to 75 phr, in particular 10 to 60 phr.

Vulcanization may be performed in the presence of sulfur or sulfur donors, with some sulfur donors able to act as vulcanization accelerants at the same time. Sulfur or sulfur donors are added to the rubber compound in the last mixing step in the amounts commonly used by a person skilled in the art (0.4 to 4 phr, sulfur preferably in amounts of 1.5 to 2.5 phr).

In general, other vulcanization systems are, however, also conceivable, for example peroxide-based systems.

Furthermore, the rubber compound may contain customary amounts of other vulcanization-influencing substances such as vulcanization accelerants, vulcanization retardants and vulcanization activators in order to control the required vulcanization time and/or temperature and to improve the vulcanisate properties. The vulcanization accelerants may be selected, for example, from the following groups of accelerants: thiazole accelerants such as 2-mercaptobenzothiazole, sulfenamide accelerants such as benzothiazyl-2-cyclohexyl sulfenamide (CBS), guanidine accelerants such as N,N′-diphenylguanidine (DPG), dithiocarbamate accelerants such as zinc dibenzyldithiocarbamate, disulfides. Combinations of the accelerants may also be used, which can produce synergistic effects.

Depending on the area of application, the constituents of the composition according to the invention may be varied. For instance, both the rubber components and the benzylated alkylphenol novolak resin may be selected such that the properties of the vulcanized product can be optimized.

For example, what would be conceivable for tire parts, such as tread compounds or side wall compounds, is a composition containing the following constituents:
a) up to 100 phr of BR, preferably 10-80 phr
b) up to 100 phr of NR, preferably 10 to 80 phr
c) up to 100 phr of ESBR and/or SSBR, preferably 10 to 100 phr
d) 0.1 to 30 phr of benzylated alkylphenol novolak resin, preferably 1 to 10 phr, in turn preferably 2-6 phr
e) 0.1 to 400 phr of other additives.

The composition according to the invention may be prepared in a conventional manner in two stages, the initial stage generally being to prepare a base mixture containing all constituents except for the vulcanization system (sulfur and vulcanization-influencing substances) in one or more mixing stages, for example with an intermeshing internal mixer, and the subsequent stage being to produce the final mixture on a roll at a relatively low temperature by adding the vulcanization system. The mixture is discharged and cooled and can be stored for a few days until final vulcanization.

If the mixture produced is to be used as a side wall or tread for tyres, it is applied as a blank to the pre-assembled green tire in a known manner.

In general, it is, however, also possible to use the composition according to the invention for other tire parts.

Furthermore, the composition according to the invention may be used for a multiplicity of other fields of application of crosslinked rubber products, for example for manufacturing industrial rubber goods, such as damping elements, rubber sleeves, drive belts, gaskets, bellows and/or conveyor belts. The composition according to the invention may also be used in the layers which need to have good adhesion in relation to inserted fabrics or meshes of metallic and/or textile reinforcing supports.

### EXAMPLES

The invention will be more particularly elucidated on the basis of an exemplary embodiment.

### Preparing the Alkylphenol Novolak Resin:

The alkylphenol novolak resin can be prepared by the known methods. The alkylphenol (or mixtures of alkylphenols, with or without phenols) is optionally melted, an acid catalyst is added (e.g. oxalic acid, p-toluenesulfonic acid, dodecylphenolsulfonic acid) and formaldehyde is metered in over 1 h at approx. 100° C. This is then further reacted for 1-3 h until the formaldehyde content has fallen to <1%. Thereafter, distillation is carried out under standard pressure to 160° C. and under reduced pressure to 170-220° C. The resin melt is poured out and cooled.

As per Table 3, the alkylphenols used were p-tert-butylphenol, p-tert-octylphenol, isononylphenol, with the corresponding alkylphenol novolak resin being prepared under the alkylphenol: formaldehyde molar ratio (MV) specified) (Table 3: compounds I, III, V, VII).

### Preparing a Benzylated Alkylphenol Novolak Resin:

The alkylphenol novolak prepared in a) is admixed with an appropriate amount of benzyl alcohol (molar ratio of alkylphenol novolak resin to benzyl alcohol: 1:1.8) and heated to 140-160° C. A sulfonic acid or sulfuric acid is added. The reaction is allowed to run at 140-160° C. für approx. 2-6 h until the benzyl alcohol content has fallen considerably. The water formed can be optionally removed at the same time. Thereafter, distillation is carried out under reduced pressure to 170-220° C. to remove the water. The resin melt is poured out and cooled.

As per Table 3, compounds II, IV, VI and VIII were prepared in this way.

### Composition and Preparing the Inventive Composition for a Tire Side Wall Compound

TABLE 1

| | Content [phr] | |
|---|---|---|
| Constituent | Comparative | Inventive |
| Tire side wall compound | A | B |
| Natural rubber, R RSS1 | 40.0 | 40.0 |
| Cis-BR, Buna CB 22 | 60.0 | 60.0 |
| Carbon black, N660 | 50.0 | 50.0 |
| Plasticizer (treated distillate aromatic extract (TDAE)) | 5.0 | 5.0 |
| Zinc oxide | 3.0 | 3.0 |
| Ageing inhibitor (6PPD Vulkanox ® 4020) | 2.0 | 2.0 |
| Ageing inhibitor (TMQ Vulkanox ® HS) | 1.5 | 1.5 |
| Wax, Antilux ® 500 | 2.0 | 2.0 |
| Alkylphenol novolak resin prepared according to a): | 4.00 | — |
| I as per Table 3: p-tert-butylphenol novolak resin (MV = 1:0.80) | | |
| Benzylated alkylphenol novolak resin prepared according to b): | — | 4.00 |
| II as per Table 3: benzylated p-tert-butylphenol novolak resin | | |
| (MV = 1:0.80) | | |

### Mixing Sequence:

0-0.5 min rubber component
0.5-1.5 min ⅔ carbon black, zinc oxide, resin, wax, 6PPD, TMQ
1.5-3.0 min ⅓ carbon black and plasticizer
5.0-6.0 min increase speed to 70 rpm, reach 120° C. target temperature

The constituents were mixed together in a kneader already at the appropriate temperature at a rotor speed of 40 rpm for 3 min. Thereafter, the rotor speed was increased to 70 rpm and the mixture was ejected at a temperature of 120° C. The mixture was homogenized on a mill and cooled to 60° C. and the following constituents were mixed in:

| | | |
|---|---|---|
| Sulfur | 2.0 | 2.0 |
| Accelerant, Rhenogran ® CBS 80 | 1.25 | 1.25 |
| Accelerant, Rhenogran ® DPG 80 GE | 0.3 | 0.3 |
| Retardant, Vulcalent ® E/C | 0.3 | 0.3 |

TABLE 2
Composition and preparing the inventive composition for a passenger vehicle tread compound.

| | Content [phr] | | Content [phr] | |
|---|---|---|---|---|
| Constituent | Comparative | Inventive | Comparative | Inventive |
| Passenger vehicle tread compound | C | D | E | F |
| SBR, Buna 1500 | 100 | 100 | 100 | 100 |
| Carbon black, N220 | 70 | 70 | 70 | 70 |
| Plasticizer (treated distillate aromatic extr. | 30 | 30 | 30 | 30 |
| (TDAE)) | | | | |
| Zinc oxide | 3 | 3 | 3 | 3 |
| Ageing inhibitor (6PPD Vulkanox ® 4020) | 2 | 2 | 2 | 2 |
| Ageing inhibitor (TMQ Vulkanox ® HS) | 2 | 2 | 2 | 2 |
| Alkylphenol novolak resin prepared according | 4 | | | |
| to a): | | | | |
| I as per Table 3: p-tert-butylphenol novolak | | | | |
| resin (MV = 1:0.80) | | | | |
| Alkylphenol novolak resin prepared according | | | 4 | |
| to a): | | | | |
| V as per Table 3: nonylphenol novolak resin | | | | |
| (MV = 1:0.89) | | | | |
| Benzylated alkylphenol novolak resin | | 4 | | |
| prepared according to b): | | | | |
| II as per Table 3: benzylated p-tert- | | | | |
| butylphenol novolak resin (MV = 1:0.80) | | | | |
| Benzylated alkylphenol novolak resin | | | | 4 |
| prepared according to b): | | | | |
| VI as per Table 3: benzylated nonylphenol | | | | |
| novolak resin (MV = 1:0.89) | | | | |

### Mixing Sequence:

0-1.0 min rubber component
1.0-4.0 min ⅔ carbon black, zinc oxide, resin, 6PPD, TMQ
4.0-6.5 min ⅓ carbon black and plasticizer
5.0-6.5 min increase speed to 70 rpm, achieve 120° C. target temperature

The constituents were mixed together in a kneader already at the appropriate temperature at a rotor speed of 40 rpm for 3 min. Thereafter, the rotor speed was increased to 70 rpm and the mixture was ejected at a temperature of 120° C. The mixture was homogenized on a mill and cooled to 60° C. and the following constituents were mixed in:

| | | | | |
|---|---|---|---|---|
| Sulfur | 1.75 | 1.75 | 1.75 | 1.75 |
| Accelerant, Rhenogran ® CBS 80 | 1.25 | 1.25 | 1.25 | 1.25 |
| Accelerant, Rhenogran ® DPG 80 GE | 0.3 | 0.3 | 0.3 | 0.3 |
| Retardant, Vulcalent ® E/C | 0.3 | 0.3 | 0.3 | 0.3 |

The benzylated/non-benzylated alkylphenol novolak resins prepared according to a) and b) and the compositions prepared in c) and d) were subjected to various tests (see Table 3) under the following conditions:
a) melt viscosity: ISO 2884-1
b) melting range, capillary method [° C.], R&K method [° C.]: DIN EN ISO 3146, DIN ISO 4625
c) OH number [mg KOH/g]: DIN 53240
d) water content [%]: Karl Fischer method, DIN 51777
e) measurement of free alkylphenol [%] by gas chromatography
f) measurement of tack

The tack of the mixture was tested against itself in a Hock tester. To this end, the mixtures were rolled out into sheets and were in each case tested after storage for one day or 5 days. The test was done at room temperature at a contact force of 50 N and a contact time of 10 s. The test was carried out in quintuplicate.

TABLE 3

| | | II-invention, | | IV-invention, |
|---|---|---|---|---|
| | I-comp, | prepared as per | III-comp, | prepared as |
| | prepared as | b) | prepared as | per b) |
| | per a) | p-tert- | per a) | p-tert- |
| | p-tert- | butylphenol, | p-tert- | octylphenol, |
| | butylphenol | benzylated | octylphenol | benzylated |
| MV (alkylphenol to HCHO) | 0.80 | 0.80 | 0.80 | 0.80 |
| Melt viscosity, 175° C. [mPas] | 2240 | 610 | 310 | 300 |
| Melt viscosity, 150° C. [mPas] | — | — | 1920 | 1560 |
| Melting range, capillary | 122/125 | 107/110 | 80/83 | 72/75 |
| method [° C.] | | | | |
| Melting range, R&K method | 139 | 125 | 98 | 91 |
| [° C.] | | | | |
| OH number [mg KOH/g] | 351 | 319 | 259 | 228 |
| Water content [%] | 0.04 | 0.02 | 0.26 | 0.06 |
| Butylphenol content [%] | 1.37 | 0.04 | — | — |
| Octylphenol content [%] | — | — | 2.44 | 0.57 |
| Nonylphenol content [%] | — | — | — | — |
| Side wall compound | A | B | | |
| Tack on day 1 | 137 | 136 | | |
| Tack on day 5 | 132 | 121 | | |
| Tread compound | C | D | | |
| Tack on day 1 | 152 | 144 | | |
| Tack on day 5 | 149 | 145 | | |

| | | VI-invention, | | VIII-invention, |
|---|---|---|---|---|
| | V-comp, | prepared as | VII-comp, | prepared as per |
| | prepared as | per b) | prepared as | b) |
| | per a) | iso- | per a) | p-tert- |
| | iso- | nonylphenol, | p-tert- | butylphenol, |
| | nonylphenol | benzylated | butylphenol | benzylated |
| MV (alkylphenol to HCHO) | 0.89 | 0.89 | 0.70 | 0.70 |
| Melt viscosity, 175° C. [mPas] | 1240 | 1000 | 140 | — |
| Melt viscosity, 150° C. [mPas] | 8320 | 5120 | 1400 | 520 |
| Melting range, capillary | 81/84 | 70/73 | 97/100 | 81/84 |
| method [° C.] | | | | |
| Melting range, R&K method | Not | Not | Not measured | Not measured |
| [° C.] | measured | measured | | |
| OH number [mg KOH/g] | Not | Not | Not measured | Not measured |
| | measured | measured | | |
| Water content [%] | 0.38 | 0.02 | 0.15 | 0.19 |
| Butylphenol content [%] | — | — | 4.27 | 0.13 |
| Octylphenol content [%] | — | — | — | — |
| Nonylphenol content [%] | 0.17 | <0.1 | — | — |
| Side wall compound | | | | |
| Tack on day 1 | | | | |
| Tack on day 5 | | | | |
| Tread compound | E | F | | |
| Tack on day 1 | 141 | 138 | | |
| Tack on day 5 | 125 | 118 | | |

The results in Table 3 show that the benzylated alkylphenol novolak resins II, IV, VI and VIII according to the invention have a lower melt viscosity, measured at 150° C. and at 175° C., and lower melting ranges than the non-benzylated alkylphenol novolak resins I, III, V and VII. This effect was surprisingly for a person skilled in the art because of the increase in molar mass due to the benzylation reaction and thus expected higher viscosities and melting ranges.

As already stated at the start, lowering the melt viscosity and also the melting range has a positive influence on the processability of the mixture. This is associated with time and energy savings in providing the rubber compound and, at the same time, the service life of mixers and moulds can be increased. The mixtures can be prepared at a lower temperature, thereby reducing the emission of hazardous gases, which makes it possible to prepare the composition according to the invention in an environmentally friendly way and in line with occupational safety requirements.

DMA measurements were made to determine glass transition temperatures (TG values) and tan delta values at 0° C. and 60° C., which demonstrate that the wet grip properties or rolling resistance of the vulcanized compositions containing benzylated alkylphenol novolak resins were virtually identical to the compositions comprising unbenzylated alkylphenol novolak resins.

1. A composition containing at least one base polymer and at least one benzylated alkylphenol novolak resin, wherein
a) the base polymer is selected from at least one rubber component and
b) the benzylated alkylphenol novolak resin has been prepared by reacting the alkylphenol novolak resin with a benzylating agent.

2. The composition of claim 1, characterized in that the rubber component is selected from the group of the natural and synthetic polyisoprenes, styrene-butadiene copolymers, polybutadienes, polyisobutylenes, isobutene-isoprene copolymers, acrylonitrile-butadiene copolymers and polyoctenamers, propylene-ethylene copolymers, ethylene-propylene-diene copolymers, halobutyl rubbers, chloroprene rubbers, isoprene-butadiene copolymers and/or styrene-isoprene-butadiene terpolymers.

3. The composition of claim, characterized in that the benzylated alkylphenol novolak resin has been prepared by benzylation of an alkylphenol aldehyde resin.

4. The composition of claim 1, characterized in that the benzylated alkylphenol novolak resin has been prepared by benzylation of an alkylphenol acetylene resin.

5. The composition of claim 1, characterized in that the benzylated alkylphenol novolak resin has been prepared using a C4-C12-alkyl phenol.

6. The composition of claim 5, wherein the alkylphenol is butylphenol isomers and/or tert-butylphenol and/or butylphenol and/or octylphenol isomers and/or tert-octylphenol and/or octylphenol and/or nonylphenol isomers and/or dodecylphenol isomers.

7. The composition of claim 1, further comprising one or more additives selected from the group consisting of resins, processing aids, fillers, ageing inhibitors, activators, plasticizers, vulcanization aids and vulcanization accelerants.

8. The composition of claim 1, wherein the composition contains 0.1 to 30 phr of benzylated alkylphenol novolak resin.

9. The composition of claim 8, wherein the composition contains 1-10 phr of benzylated alkylphenol novolak resin.

10. The composition of claim 8, wherein the composition contains 2 to 6 phr of benzylated alkylphenol novolak resin.

11. The composition of claim 1, wherein the composition comprises the following constituents:
a) up to 100 phr of BR, preferably 10-80 phr
b) up to 100 phr of NR, preferably 10 bis 80 phr
c) up to 100 phr of ESBR and/or SSBR, preferably 10 bis 100 phr
d) 0.1 bis 30 phr of benzylated alkylphenol novolak resin, preferably 1 to 10 phr, in turn preferably 2-6 phr, and
e) 0.1 to 400 phr of other additives.

12. Use of the composition according to claim 1 for manufacturing crosslinked rubber products.

13. Use of the composition according to claim 12 for manufacturing tire parts.

14. Use of the composition according to claim 12 for manufacturing tire side walls and/or tire treads.
